(19) United States
(12) Patent Application Publication
(10) Pub. No.: US 2021/0145022 A1
(43) Pub. Date: May 20, 2021

(54) PROTEIN PRODUCT AND METHODS FROM ACID TREATED MEAT EMULSION

(71) Applicant: Cargill, Incorporated, Wayzata, MN (US)

(72) Inventors: William R. AIMUTIS, Denver, NC (US); Mufan GUO, Wayzata, MN (US); Sonia HAN, Lauderdale, MN (US)

(21) Appl. No.: 16/623,886

(22) PCT Filed: Jun. 18, 2018
(86) PCT No.: PCT/US2018/038061

§ 371 Date: Dec. 18, 2019

Related U.S. Application Data
(60) Provisional application No. 62/523,122, filed on Jun. 21, 2017.

(51) Int. Cl. A23J 1/02; A23J 3/04; A23L 13/40; A23L 13/50; A23L 13/60; A23B 4/037

(52) U.S. Cl. CPC A23J 1/02; A23J 3/04; A23L 13/428; A23V 2002/00; A23L 13/60; A23B 4/037; A23L 13/52

(57) ABSTRACT

Meat that has been treated by a combination of comminution, treatment with alkali and drying exhibits excellent properties for use as a new food ingredient. Dried Functionalized Protein Product is prepared by comminuting meat to a particle size of less than 5 mm; mixing the comminuted meat with water, a food grade acid composition, a food grade alkaline composition, and a food grade salt to form a Functionalized Protein Brine having a pH in the range of from about 4.0 to about 9.5. The mixing is carried out so that the meat is exposed to the acid to cause the pH of the meat to be less than about 5.3 at some time during the process. The resulting Functionalized Protein Brine is dried to form a Dried Functionalized Protein Product. Water can be added to the Dried Functionalized Protein Product to form a Reconstituted Functionalized Protein Formulation.

### FIELD

The present invention relates to meat protein products and methods of making and using same.

### BACKGROUND

Protein suspensions comprising sarcoplasmic proteins and myofibrillar proteins derived from animal muscle tissue have been asserted to provide improved moisture retention in food being thawed or cooked. See US Patent Application Publication No. 2011/0244093 to Kelleher et al. This application describes obtaining animal muscle protein compositions from animal muscle tissue by comminuting the animal muscle tissue and then mixing it with a food grade alkaline composition under conditions to solubilize the animal muscle protein thereby forming a solution of animal muscle protein. The suspended basic animal muscle tissue then is mixed with a food grade alkaline composition to decrease the pH of the solubilized animal muscle protein to a pH between about 4.7 and about 11.0, preferably between about pH 5.5 and about 9.5, thereby to precipitate the protein. The precipitated protein then is comminuted to form protein particulates suspended in an aqueous medium. The thus prepared composition invention is added to a food to be thawed and/or cooked to increased moisture retention in the food. See paragraph [0010]. The pH of the solution for solubilizing the protein is disclosed to be about 10.5 or greater. See paragraph [0015].

A process for isolating proteins is described in U.S. Pat. No. 6,136,959 to Hultin et al., wherein protein is treated with base, centrifuged and acidified to precipitate the edible protein. See column 1, lines 24-35. The pH of the solution after treatment with base is disclosed to be greater than about 10.0. See column 3, lines 25-28. U.S. Pat. No. 7,556,835 likewise discloses a process for isolating proteins by solubilizing the protein in alkaline solution and precipitating the solubilized protein from the mixture. See column 1, lines 58-67. The solubilization of the protein is disclosed to be accomplished by increasing the pH of the mixture to about 10.0 or above. See column 2, lines 47-50.

A process for improving water holding capacity and tenderness in cooked protein food products is described US Patent Application Publication No. 2010/0009048 to Hultin et al (“Hultin '048”). As discussed in paragraph [0017] of Hultin '048, the food product to be treated with a pH adjusting solution is so treated by injecting with the solution, tumbling the food with the solution or soaking the food product with the solution. Thus, the food product to be treated are portions (including minced portions), and is not a comminuted meat emulsion that itself is then added to an animal muscle portion. Hultin '048 discloses incorporation of protein isolates in the pH adjusting solution. See, e.g., Paragraphs [0014] and [0015]. Hultin '048 clarifies that “[m]ethods for preparing proteins and protein isolates are known in the art and can be found, e.g., in U.S. Pat. Nos. 6,005,073, 6,136,959, 6,288,216, and 6,451,975.” See paragraph [0050]. All of these referenced patents discuss isolating the protein from the animal muscle.

Low viscosity, high gel strength protein-starch compositions are described in U.S. Pat. No. 6,187,367 to Cho et al. This patent describes spray drying a slurry of starch and protein material under conditions which cause the protein material and starch material to complex without gelatinizing the starch material. See the Abstract.

### SUMMARY

It has been found that meat that has been treated by a combination of comminution, treatment with acid and alkali, followed by drying exhibit excellent properties for use as a new food ingredient for application into various food products and beverages that would benefit from incorporation of additional protein, with the nutritional and organoleptic benefits that such a protein would provide.

A process for preparing a Dried Functionalized Protein Product is provided comprising: comminuting meat to form a comminuted meat having particle size of less than 5 mm; mixing the comminuted meat with water, a food grade alkaline composition, a food grade acid composition, and a food grade salt to form a Functionalized Protein Brine having a pH in the range of from about 4.0 to about 9.5. The mixing is carried out so that the meat is exposed to the acid in a manner that would cause the pH of the meat to be less than about 5.3 at some time during the process to form the Functionalized Protein Brine. The resulting Functionalized Protein Brine is dried to form a Dried Functionalized Protein Product. In an aspect, the Functionalized Protein Brine is dried by a freeze drying process. In an aspect, the Functionalized Protein Brine is dried by a spray drying process.

In an aspect, a Dried Functionalized Protein Product made by this process is also provided.

In another aspect, a process for preparing a Reconstituted Functionalized Protein Formulation comprises reconstituting the Dried Functionalized Protein Product described herein with sufficient water to form a Reconstituted Functionalized Protein Formulation having a meat content (i.e. all solids components of meat, including protein, fat, etc) of from about 3 wt % to about 35 wt %, or from about 5 wt % to about 25 wt %, or from about 7 wt % to about 15 wt %, based on total weight of the Reconstituted Functionalized Protein Formulation. In an aspect, the meat of any of the above recited Reconstituted Functionalized Protein Formulations is poultry. In an aspect, the meat of any of the above recited Reconstituted Functionalized Protein Formulations is chicken. In an aspect, the meat of any of the above recited Reconstituted Functionalized Protein Formulations is beef.

In another aspect, a process of using the Reconstituted Functionalized Protein Formulation described herein comprises incorporating said Reconstituted Functionalized Protein Formulation into a food system selected from the group consisting of a beverage and a sauce (such as a salad dressing).

In another aspect, a process of using the Reconstituted Functionalized Protein Formulation described herein, wherein the meat is poultry, comprising incorporating said Reconstituted Functionalized Protein Formulation into a food system selected from the group consisting of bread and a frozen foamed dessert (such as such as ice cream, frozen custard, frozen yogurt, sorbet, and gelato).

In an aspect, at least about 70% by weight of the protein of the meat in the comminuted meat emulsion is solubilized, and the protein of the meat in the comminuted meat emulsion is not isolated from the meat in the comminuted meat emulsion. In an aspect, no more than about 30% by weight of the protein of the meat in the comminuted meat emulsion is precipitated.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings, which are incorporated in and constitute a part of this application, illustrate several aspects of the invention and together with a description of the embodiments serve to explain the principles of the invention. A brief description of the drawings is as follows:

FIG. 1 is a graph showing the emulsion capacity values of the Chicken untreated Control as compared to the Chicken Acid treated samples in both the undried and reconstituted freeze dried compositions.

FIG. 2 is a graph showing the Foaming Capacity properties of the Chicken and Beef untreated Controls as compared to the Chicken and Beef Acid treated samples in both the undried and reconstituted freeze dried compositions.

FIG. 3 is a graph showing the Gel Hardness properties of the Chicken and Beef untreated Controls as compared to the Chicken and Beef Acid treated undried samples.

### DETAILED DESCRIPTION

The aspects of the present invention described below are not intended to be exhaustive or to limit the invention to the precise forms disclosed in the following detailed description. Rather a purpose of the aspects chosen and described is by way of illustration or example, so that the appreciation and understanding by others skilled in the art of the general principles and practices of the present invention can be facilitated.

The meat used in the process described herein may in an aspect be any variety of meat from any species. In an aspect, suitable meats include those obtained from bovine, porcine, equine, caprine, ovine, avian animals, fish or other seafood, or any animal commonly slaughtered for food production. Bovine animals may include, but are not limited to, buffalo, and all cattle, including steers, heifers, cows, and bulls. Porcine animals may include, but are not limited to, feeder pigs and breeding pigs, including sows, gilts, barrows, and boars. Ovine animals may include, but are not limited to, sheep, including ewes, rams, wethers, and lambs. Poultry may include, but are not limited to, chicken, turkey, and ostrich. In an aspect, the meet is beef, pork, turkey or chicken. In a preferred aspect, the meat comprises poultry meat, and the meat is chicken.

In an aspect, the comminuted meat emulsion is at least about 80% lean, or at least about 85% lean, or at least about 90% lean, or at least about 95% lean.

In an aspect, the myofibrillar protein is at least about 1.5 wt % of the comminuted meat emulsion. In an aspect, the myofibrillar protein is from about 1.5 wt % to about 10 wt % of the comminuted meat emulsion. In an aspect, the myofibrillar protein is at least from about 1.5 wt % to about 10 wt % of the comminuted meat emulsion.

In an aspect, the meat of the comminuted meat emulsion is comminuted by chopping, grinding, or flaking prior to emulsification according to well-known procedures. In an aspect, the meat is comminuted into fine particles by apparatus having one or more rotating blades or one or more reciprocating blades.

In an aspect, the meat is first provided in portion size without being comminuted, and is mixed with a food grade acid composition to form a composition having a pH of from about 2.0 to about 5.3. After formation of this mixture, the meat is then comminuted to the desired end particle size in one or more comminution steps and mixed with mixed with a food grade alkaline composition to form a comminuted meat emulsion having a pH of from about 4.0 to about 9.5.

In an aspect, the meat is comminuted to form a comminuted meat having an intermediate particle size that is larger than the desired end particle size, which is then mixed with a food grade acid composition to form a composition having a pH of from about 2.0 to about 5.3. This composition is then mixed with a food grade alkaline composition to form a mixture having a pH of from about 6.5 to about 9.5. In this aspect, the step of mixing the comminuted meat with the food grade alkaline composition comprises additional comminution to further reduce particle size of in one or more further comminution steps to form a comminuted meat emulsion having a pH of from about 6.5 to about 9.5.

In an aspect, the comminuted meat is comminuted to the desired end particle size in one or more comminution steps before being mixed with the food grade acid composition to form a composition having a pH of from about 2.0 to about 5.3. The comminuted meat is then mixed with the food grade alkaline composition to form a comminuted meat emulsion having a pH of from about 6.5 to about 9.5.

In an aspect, the meat is comminuted in one or more intermediate comminution steps to form a comminuted meat having an average particle size of from about 1 mm to about 10 mm in the longest dimension, or from about 1 to about 5 mm in the longest dimension, or from 1 mm to about 3 mm, or from about 1 to about 2 mm in the longest dimension.

In an aspect, the particles of the comminuted meat emulsion have an average particle size of less than about 3 mm, or less than about 2 mm, or less than about 1 mm, or less than about 0.5 mm, or less than about 0.1 mm. In an aspect, the particles of the comminuted meat emulsion have an average particle size of from about 0.1 to about 3 mm, or from about 0.1 to about 3 mm, or from about 0.1 to about 0.4 mm, or from about 1 to about 3 mm. In an aspect, the particles of the comminuted meat emulsion have a maximum particle size of less than about 1 mm, or less than about 0.5 mm. In an aspect, the comminuted meat is substantially free of particles of larger than 1 mm.

In an aspect, the food grade acid composition is an acid composition comprising one or more acid materials selected from citric acid, ascorbic acid, lactic acid, malic acid, phosphoric acid, tartaric acid, fumaric acid, formic acid and the like.

In an aspect, the food grade alkaline composition is an alkaline composition comprising one or more alkaline materials selected from sodium hydroxide, potassium hydroxide, sodium bicarbonate, potassium bicarbonate, or mixtures thereof or the like. In an aspect, the food grade alkaline composition is an alkaline composition consisting of sodium bicarbonate or potassium bicarbonate or mixtures thereof. In an aspect, the food grade alkaline composition is an alkaline composition consisting of sodium bicarbonate. In an aspect, the food grade alkaline composition is an alkaline composition consisting of potassium bicarbonate. In an aspect, the food grade alkaline composition is an alkaline composition consisting of calcium bicarbonate. In an aspect, the food grade alkaline composition is a carbonate, bicarbonate, or a hydroxide composition comprising counterions selected from the group consisting of sodium, potassium, calcium, magnesium or mixtures thereof. The alkaline composition may be provided in solution or in dry form.

In an aspect, the comminuted meat emulsion has a pH of from about 2.0 to about 5.3 at some time during the process to form the Functionalized Protein Brine.

In an aspect, the comminuted meat emulsion has a pH of from about 6.5 to about 9.5 during the process to form the Functionalized Protein Brine. In an aspect, the comminuted meat emulsion has a pH of from about 7 to about 9 during the process to form the Functionalized Protein Brine. In an aspect, the comminuted meat emulsion has a pH of from about 7.5 to about 8.5 during the process to form the Functionalized Protein Brine.

In an aspect, the comminuted meat emulsion has a table salt content of from about 1% wt to about 10% wt during the process to form the Functionalized Protein Brine. In an aspect, the comminuted meat emulsion has a table salt content of from about 2% wt to about 6% wt, or from about 3% wt to about 5% wt, during the process to form the Functionalized Protein Brine. In an aspect, the comminuted meat emulsion has an ionic strength of from about 0.2M to about 4M pri during the process to form the Functionalized Protein Brine. In an aspect, the comminuted meat emulsion has an ionic strength of from about 1M to about 3M during the process to form the Functionalized Protein Brine. For purposes of the present invention, a table salt is a salt selected from sodium chloride, potassium chloride and magnesium chloride and mixtures thereof. The table salt may be provided as purified salt, or may be provided in a technically impure form such as a sea salt or other natural sourced salt. In an aspect, the salt is an iodized salt. It has been found that comminuted meat emulsions comprising table salt are particularly advantageous because salt helps to solubilize and functionalize in particular the myofibrillar proteins of the muscle, and thereby increases water holding capacity and binding property in a manner that additionally provides organoleptic benefit.

Careful control of the pH and ionic strength of the comminuted meat emulsion in all phases of the present method provides excellent properties in the final meat product. Such control has been found to promote solubility of the protein of the meat in the comminuted meat emulsion. In an aspect, at least about 70%, 75%, 80%, 85% or 90% by weight of the protein of the meat in the comminuted meat emulsion is solubilized, and the protein of the meat in the comminuted meat emulsion is not isolated from the meat in the comminuted meat emulsion. The provision of very high percentage of solubilized protein in the comminuted meat emulsion has been found to provide superior water retention properties. While not being bound by theory, it is believed that soluble proteins have great affinity for water while at the same time exhibiting affinity to any protein in the food product, and even to fat in the emulsion and or the food product. In an aspect, from about 75% to about 98% by weight of the protein of the meat in the comminuted meat emulsion is solubilized. In an aspect, from about 80% to about 95% by weight of the protein of the meat in the comminuted meat emulsion is solubilized. In an aspect, no more than about 30%, 25%, 20%, 15% or 10% by weight of the protein of the meat in the comminuted meat emulsion is precipitated. In an aspect, from about 30% to about 2% by weight of the protein of the meat in the comminuted meat emulsion is precipitated. In an aspect, from about 25% to about 5% by weight of the protein of the meat in the comminuted meat emulsion is precipitated. While not being bound by theory, it is believed that precipitated protein self-isolates from water, other proteins, fats and other ingredients in the emulsion and/or the food product. This self-isolation is believed to limit interaction of the precipitated protein with the other ingredients, providing lower product benefit as compared to solubilized proteins.

In an aspect, the comminuted meat emulsion may be sodium-free, (i.e., the comminuted meat emulsion has a sodium content at or less than about 1 ppm). In further aspects, the comminuted meat emulsion may comprise phosphate, for example in the form of sodium phosphate. In further aspects, comminuted meat emulsion may be phosphate-free (i.e., the comminuted meat emulsion has a phosphate content at or less than about 1 ppm).

In an aspect, the comminuted meat emulsion has a fat content of less than 60% by weight, 40% by weight, 30% by weight, 20% by weight, or less than 15% or less than 10% or less than 5% by weight.

In an aspect, the resulting Functionalized Protein Brine is then dried to form a Dried Functionalized Protein Product by any appropriate freeze drying technique. In an aspect, Functionalized Protein Brine is placed in a freeze drying chamber under freeze drying conditions for a time sufficient for the weight of the product to be stable over a 24 hour period, indicating no additional water can be removed from the sample under the freeze drying conditions. In an aspect, the freeze drying conditions comprise freezing the samples at −20° C. for 12 hours, and then placing the sample in a freeze dryer at −50° C. and 0.0030 mbar.

In an aspect, the resulting Functionalized Protein Brine is then dried to form a Dried Functionalized Protein Product by any appropriate spray drying technique. In an aspect, Functionalized Protein Brine is dried by injecting the Functionalized Protein Brine into a dryer under pressure through an atomizer and passing the atomized Functionalized Protein Brine through a dryer together with hot air in a co-current flow. In an aspect, the atomizer is a nozzle atomizer. In an aspect, the atomizer is a rotary atomizer.

In an aspect, the Dried Functionalized Protein Product when free of added starches and gums has an Emulsion Capacity of greater than 200 g oil/g protein.

For purposes of the present invention, “Emulsion Capacity” is defined as the amount of oil that can be added into a 1% protein solution under continuous mixing with a food processor before breaking of the emulsion, detectable either through ribboning or visible thinning of the sample.

In an aspect, the Dried Functionalized Protein Product when free of added starches and gums does not exhibit K-Carrageenan Hydrocolloid Separation, or does not exhibit Iota-Carrageenan Hydrocolloid Separation, or does not exhibit Guar Gum Hydrocolloid Separation. For purposes of the present invention, a Dried Functionalized Protein Product does not exhibit K-Carrageenan Hydrocolloid Separation, or does not exhibit Iota-Carrageenan Hydrocolloid Separation, or does not exhibit Guar Gum Hydrocolloid Separation if when a solution of 1% by weight protein is mixed with the indicated hydrocolloid at 0.10% w/w) at room temperature until the mixture was homogenous, held for 12 hours at 4° C., and centrifuged at 3,000 rpm (1409 g) at room temperature for 15 min, no phase separation can be visually observed.

In an aspect, the Dried Functionalized Protein Product where the meat is poultry when free of added starches and gums has a Gel Hardness of greater than 90 g, or has a Gel Hardness of from about 90 g to about 300 g, or from about 90 g to about 200 g, or from about 90 g to about 150 g. In an aspect, the Dried Functionalized Protein Product where the meat is chicken when free of added starches and gums has a Gel Hardness of greater than 90 g, or has a Gel Hardness of from about 90 g to about 300 g, or from about 90 g to about 200 g, or from about 90 g to about 150 g.

In an aspect, the Dried Functionalized Protein Product where the meat is poultry when free of added starches and gums has a Foaming Capacity of greater than 60 ml foam/g protein. In an aspect, the Dried Functionalized Protein Product where the meat is chicken when free of added starches and gums has a Foaming Capacity of greater than 60 ml foam/g protein.

In an aspect, the Dried Functionalized Protein Product where the meat is poultry when free of added starches and gums has a Viscosity of greater than 3 Pa·s when measured at a shear rate of 0.1 l/s. In an aspect, the Dried Functionalized Protein Product where the meat is chicken when free of added starches and gums has a Viscosity of greater than 3 Pa·s when measured at a shear rate of 0.1 l/s.

In an aspect, the Dried Functionalized Protein Product where the meat is poultry when free of added starches and gums has a Viscosity of greater than 0.3 Pa·s when measured at a shear rate of 1.0 l/s. In an aspect, the Dried Functionalized Protein Product where the meat is chicken when free of added starches and gums has a Viscosity of greater than 0.3 Pa·s when measured at a shear rate of 1.0 l/s.

In an aspect, the Dried Functionalized Protein Product where the meat is beef when free of added starches and gums has a Viscosity of greater than 1 Pa·s when measured at a shear rate of 0.1 l/s.

In an aspect, the Dried Functionalized Protein Product where the meat is beef when free of added starches and gums has a viscosity of greater than 0.2 Pa·s when measured at a shear rate of 1.0 l/s.

In an aspect, the Dried Functionalized Protein Product where the meat is beef when free of added starches and gums has a Gel Hardness of greater than 400 g, or has a Gel Hardness of from about 450 g to about 650 g, or from about 500 g to about 550 g.

In an aspect, a Dried Functionalized Protein Product is provided that is made by any of the processes as described herein. In an aspect, the Dried Functionalized Protein Product is free of added starches and gums.

In another aspect, a process for preparing a Reconstituted Functionalized Protein Formulation comprises reconstituting the Dried Functionalized Protein Product described herein with sufficient water to form a Reconstituted Functionalized Protein Formulation having a meat content (i.e. all solids components of meat, including protein, fat, etc) of from about 3 wt % to about 35 wt %, or from about 5 wt % to about 25 wt %, or from about 7 wt % to about 15 wt %, based on total weight of the Reconstituted Functionalized Protein Formulation. In an aspect, the Reconstituted Functionalized Protein Formulation having the indicated meat contents have a viscosity of greater than 1 Pa·s when measured at a shear rate of 0.1 l/s, or a viscosity of from 1 Pa·s to 500 Pa·s when measured at a shear rate of 0.1 l/s, or from 3 Pa·s to 200 Pa·s when measured at a shear rate of 0.1 l/s, or from 3 Pa·s to 100 Pa·s when measured at a shear rate of 0.1 l/s. In an aspect, the Reconstituted Functionalized Protein Formulation having the indicated meat contents have a viscosity of greater than 0.3 Pa·s when measured at a shear rate of 1 l/s, or a viscosity of from 0.3 Pa·s to 500 Pa·s when measured at a shear rate of 1 l/s, or from 0.8 Pa·s to 200 Pa·s when measured at a shear rate of 1 l/s, or from 0.8 Pa·s to 100 Pa·s when measured at a shear rate of 1 l/s. In an aspect, the meat of any of the above recited Reconstituted Functionalized Protein Formulations is poultry. In an aspect, the meat of any of the above recited Reconstituted Functionalized Protein Formulations is chicken. In an aspect, the meat of any of the above recited Reconstituted Functionalized Protein Formulations is beef.

In an aspect, the Reconstituted Functionalized Protein Product may also include a variety of optional additives. Examples of suitable additives may include salts, synthetic antioxidants, natural antioxidants such as rosemary, and antimicrobials (e.g. bacterial and other pathogen inhibitors such as sodium or potassium lactate). In an aspect, the comminuted meat emulsion comprises natural antibacterial agents as defined by the USDA, such as vinegar, lemon juice, sea salt, and blends thereof (such as MOstatin™ LV1Xm an all natural blend of vinegar and lemon juice from World Technology Ingredients in Jefferson, Ga.). The antibacterial agents may also be buffered, such as MOstatin™ V (buffered vinegar), or formulated for low sodium, such as MOstatin™ VLS (low sodium vinegar), both also from World Technology Ingredients in Jefferson, Ga.

In an aspect, a Dried Functionalized Protein Product is used by incorporating said Dried Functionalized Protein Product into a food system selected from the group consisting of a beverage and a sauce (such as a salad dressing). In an aspect, the beverage is a protein enhanced beverage such as a protein supplemented milk or milk product, a protein supplemented soy milk, or a protein supplemented smoothie or shake. In an aspect, the Dried Functionalized Protein Product is added to such a beverage in an amount of from about 0.1% to about 20% by weight using standard addition process techniques as are known in the food supplementation art.

In an aspect, a Reconstituted Functionalized Protein Product is used by incorporating said Reconstituted Functionalized Protein Formulation into a food system selected from the group consisting of a beverage and a sauce (such as a salad dressing). In an aspect, the beverage is a protein enhanced beverage such as a protein supplemented milk or milk product, a protein supplemented soy milk, or a protein supplemented smoothie or shake. In an aspect, the Reconstituted Functionalized Protein Product is added to such a beverage in an amount of from about 0.1% to about 20% by weight using standard addition process techniques as are known in the food supplementation art.

In an aspect, a Dried Functionalized Protein Product wherein the meat is poultry is used by incorporating said Reconstituted Functionalized Protein Formulation into a food system selected from the group consisting of bread and a frozen foamed or gelled dessert (such as such as ice cream, frozen custard, frozen yogurt, sorbet, and gelato). In an aspect, the meat that is poultry is chicken. In an aspect, the Dried Functionalized Protein Product is added to bread in an amount of from about 0.1% to about 5% by weight using standard addition process techniques as are known in the food supplementation art. In an aspect, the Dried Functionalized Protein Product is added to a frozen foamed or gelled dessert in an amount of from about 0.1% to about 5% by weight using standard addition process techniques as are known in the food supplementation art.

In an aspect, a Reconstituted Functionalized Protein Product wherein the meat is poultry is used by incorporating said Reconstituted Functionalized Protein Formulation into a food system selected from the group consisting of bread and a frozen foamed or gelled dessert (such as such as ice cream, frozen custard, frozen yogurt, sorbet, and gelato). In an aspect, the meat that is poultry is chicken. In an aspect, the Reconstituted Functionalized Protein Product is added to bread in an amount of from about 0.1% to about 5% by weight using standard addition process techniques as are known in the food supplementation art. In an aspect, the Reconstituted Functionalized Protein Product is added to a frozen foamed or gelled dessert in an amount of from about 0.1% to about 5% by weight using standard addition process techniques as are known in the food supplementation art.

In an aspect, a Dried Functionalized Protein Product is used as a texture modifier for a food product as a replacement for a hydocolloid texture modifier. In an aspect, a Dried Functionalized Protein Product is used as a texture modifier for a food product as a partial replacement for a hydocolloid texture modifier. In an aspect, a Reconstituted Functionalized Protein Product is used as a texture modifier for a food product as a replacement for a hydocolloid texture modifier. In an aspect, a Reconstituted Functionalized Protein Product is used as a texture modifier for a food product as a partial replacement for a hydocolloid texture modifier.

### Examples

### Test Protocols

Emulsion Capacity

Emulsion tests were performed using a Cuisinart HandyPrep DFP-3 food processor, 30 g of sample, and soybean oil that had been dyed red. For tests performed with an undried control sample, 30 g was weighed into the bowl and the method proceeded as follows. For dried samples, a standard testing solution of 1 wt % protein in water was prepared and then 30 g of that solution was weighed and used to perform the test. After weighing 30 g of sample into the food processor bowl, the mixer was started and oil was added continuously. The processor was stopped when the emulsion broke, detectable either through ribboning or visible thinning of the sample. The emulsion capacity was determined using Equation 1.

$$EC ( g oil / g protein ) = \frac{{W}_{3} - {W}_{2}}{{W}_{1} \times {C}_{p}} \qquad Equation 1$$

Where EC was the emulsion capacity, W₃ was the final weight of the whole food processor bowl after adding oil, W₂ was the start weight of the whole food processor bowl before adding oil, W₁ is the sample weight, Cₚ was the protein content in control sample. For dried samples, W₁×Cₚ is 0.03 g.

### Foaming Capacity and Stability

The ability of undried control and dried chicken and beef samples to foam was tested using the foaming capacity and stability tests as follows. The test was run both with the control and dried samples. For the dried samples, a standard testing solution of 1 wt % protein in water was prepared and used for the tests. 30 ml of the sample was poured into a 1000 ml beaker. Using a hand mixer (Sunbeam Mixmaster-FPSBHM1503), the sample was beaten for 2 min at setting 4 (reading 800 rpm on a tachometer) while the beaker was held at a 45 degree angle. After 2 minutes the entire contents of the beaker were poured into a 100 ml graduated cylinder, using a plastic spatula to ensure complete transfer. The levels of liquid and foam were noted at time 0 and after 30 min had elapsed. The foam capacity and stability were calculated using Equation 2 and Equation 3 respectively.

FC (ml foam volume/g protein)=V₁/W₁×Cₚ Equation 2

FS (%)=V₂/V₁×100 Equation 3

Where FC was the foaming capacity, FS was the foaming stability, V₁ was the foam volume generated at 0 min V₂ was the foam volume remained after 30 min, W₁ was the sample weight, Cₚ was the protein content in control sample. For dried samples, W₁×Cₚ was 0.03 g.

### Gelling Ability

The gelling ability of control and dried chicken and beef samples was assessed by testing the gel hardness. Gelling ability is essential in many food systems to build the texture and structure and also improve mouthfeel. 25 g of the control sample was weighed into a 50 ml centrifuge tube and heated at 85° C. for 30 min. For dried samples, a standard testing solution of 7 wt % protein in water was prepared and 25 g of that solution was weighed into a 50 ml centrifuge tube and then heated at 85° C. for 30 min. All samples were then cooled overnight in a refrigerator and tested using the Texture Analyzer (TA HD plus) at room temperature. The probe used was a knife with a 45° chiseled edge (TA 42). The pre-test speed was 5 mm/s, the test speed was 1 mm/s, the post-test speed was 3 mm/s, the distance was 10 mm, and the trigger force was 5 g. The data was analyzed using the “Hard and Sticky” macro.

### Viscosity Measurement

Undried control chicken and beef samples were run on the rheometer (Anton Paar-MCR 502) to be able to compare viscosity. Viscosity is another important parameter in addition to gelling ability when evaluating the texture and mouthfeel of various food products. For dried samples, a standard testing solution of 3 wt % protein in water is prepared. The samples are run using a cup and bob geometry (CC27-78234-3208). The samples are run at 7° C. with an equilibration step of 15 s and then the rotation is increased from 0.01-1000 l/s with 31 points of data collected with varying intervals of time (40 s initial-10 s final). The Beef Control and Acid Treated samples develop particulates during the testing process. To decrease the amount of noise this phenomenon generated in the data, the samples are strained through a fine wire mesh (1.18 mm openings) to remove particulates that are already present.

### Hydrocolloid Compatibility

For dried samples, a standard testing solution of 1 wt % protein in water was prepared, and three kinds of hydrocolloids (k-carrageenan (Satiagel ME4 SB), iota-carrageenan (Satiagel SI A), and guar gum (SAP 18785)) were mixed with this solution at different ratios (hydrocolloids concentrations are 0, 0.02, 0.04, 0.06, 0.08, 0.10% w/w) at room temperature until the mixture was homogenous. The prepared mixtures with different concentration of hydrocolloids (˜10 g) were put into 15 ml centrifuge tubes and kept overnight at 4° C. to ensure complete hydration of the hydrocolloids. Then they were centrifuged at 3,000 rpm (1409 g) at room temperature using Eppendorf 5702 clinical centrifuge for 15 min. Phase separation was detected visually. In an aspect, no K-Carrageenan Hydrocolloid Separation is observed in any of the above noted composition ratios. In an aspect, no Iota-Carrageenan Hydrocolloid Separation is observed in any of the above noted composition ratios. In an aspect, no Guar Gum Hydrocolloid Separation is observed in any of the above noted composition ratios.

### Sample Preparation

For the beef samples USDA Choice or higher grade, denuded boneless beef cap off top round muscles were used. For the chicken samples, boneless skinless chicken breasts were used. Both meats were ground to ⅛ inch particles before the protein solutions were made.

Control samples were prepared by adding the comminuted meat and water to a high speed mixer and adding salt during mixing/emulsification for 1 minute. No pH adjustment was made.

To make the Acid Treated samples, the meat and water was added to a high speed mixer. The pH was then adjusted to 3.8 using citric acid while emulsifying. Salt was then added and the pH adjusted to 7.5 using sodium carbonate solution.

All the samples were received in the liquid form and kept at −20° C. upon receipt. Prior to freezing, four 1 liter aliquots were made of each sample to make future sampling more convenient. The formulations of these compositions are set forth in Table 1.

TABLE 1
Final Brine Formulations

| | | Chicken | | Beef |
|---|---|---|---|---|
| | Chicken | Acid | Beef | Acid |
| Ingredients | Control | treated | Control | treated |
| Water | 80.67 | 73.37 | 80.67 | 73.67 |
| Meat | 13.33 | 13.33 | 13.33 | 13.33 |
| Sod Carbonate Sol. | — | 6.8 | — | 6.5 |
| Approx. Citric Acid | — | 0.5 | — | 0.5 |
| Salt | 6 | 6 | 6 | 6 |
| Total | 100 | 100 | 100 | 100 |
| Final pH | 5.72 | 7.52 | 5.3 | 7.5 |
| Brine:Meat ratio | 6.5:1 | 6.5:1 | 6.5:1 | 6.5:1 |
| % Salt | 6 | 6 | 6 | 6 |

A portion of each sample was dried for further functionality analysis. Proximate composition analysis was conducted for both control and dried samples, with results shown in Tables 2 and 3.

TABLE 2
Composition results of Chicken Control, Acid
Treated Chicken, Beef Control and Acid Treated
Beef samples that had not been freeze dried:

| %(w/w, wb) | Moisture | Protein | Fat | Ash |
|---|---|---|---|---|
| Chicken Control | 91.11 | 3.31 | 0.18 | 6.14 |
| Acid Treated Chicken | 90.09 | 3.00 | 0.19 | 6.92 |
| Beef Control | 90.31 | 2.63 | 1.25 | 6.07 |
| Acid Treated Beef | 90.17 | 2.90 | 0.97 | 6.89 |

TABLE 3
Protein content of freeze dried chicken and beef samples

| %(w/w, wb) | Protein content in freeze dried sample |
|---|---|
| Chicken Control | 35.0 |
| Acid Treated Chicken | 29.0 |
| Beef Control | 25.6 |
| Acid Treated Beef | 24.5 |

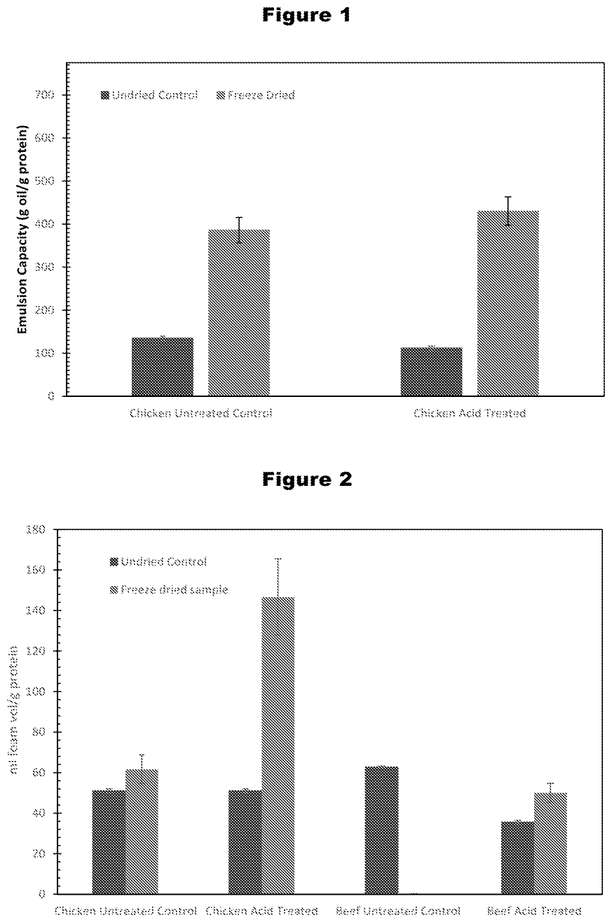

The emulsion capacity values of the Chicken untreated Control as compared to the Chicken Acid treated samples in both the undried and reconstituted freeze dried compositions are shown in FIG. 1. As can be seen, the reconstituted freeze dried compositions exhibit superior emulsion capacity properties as compared to samples that have never been freeze dried.

The Foaming Capacity properties of the Chicken and Beef untreated Controls as compared to the Chicken and Beef Acid treated samples in both the undried and reconstituted freeze dried compositions are shown in FIG. 2. As can be seen, the reconstituted freeze dried chicken Acid treated compositions exhibit superior Foaming Capacity properties as compared to chicken samples that have never been freeze dried.

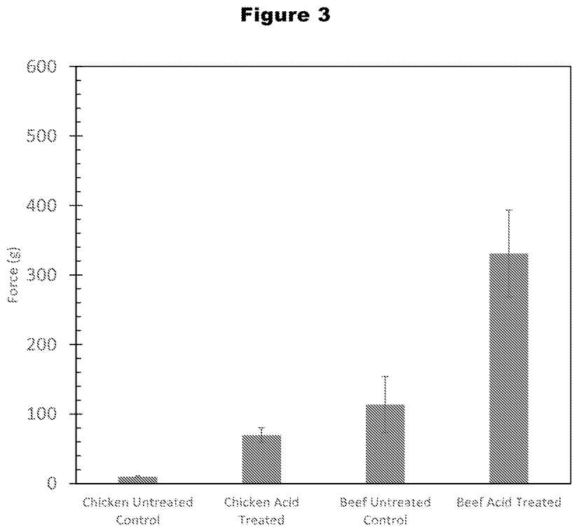

The Gel Hardness properties of the Chicken and Beef untreated Controls as compared to the Chicken and Beef Acid treated undried samples are shown in FIG. 3. As can be seen, the Chicken and Beef Acid treated undried samples exhibit superior Gel Hardness properties as compared to Chicken and Beef untreated Controls.

As used herein, the terms “about” or “approximately” mean within an acceptable range for the particular parameter specified as determined by one of ordinary skill in the art, which will depend in part on how the value is measured or determined, e.g., the limitations of the sample preparation and measurement system. Examples of such limitations include preparing the sample in a wet versus a dry environment, different instruments, variations in sample height, and differing requirements in signal-to-noise ratios. For example, “about” can mean greater or lesser than the value or range of values stated by 1/10 of the stated values, but is not intended to limit any value or range of values to only this broader definition. For instance, a concentration value of about 30% means a concentration between 27% and 33%. Each value or range of values preceded by the term “about” is also intended to encompass the aspect of the stated absolute value or range of values. Alternatively, particularly with respect to biological systems or processes, the term can mean within an order of magnitude, preferably within 5-fold, and more preferably within 2-fold, of a value.

Throughout this specification and claims, unless the context requires otherwise, the word “comprise”, and variations such as “comprises” and “comprising”, will be understood to imply the inclusion of a stated integer or step or group of integers or steps but not the exclusion of any other integer or step or group of integer or step. When used herein “consisting of” excludes any element, step, or ingredient not specified in the claim element. When used herein, “consisting essentially of” does not exclude materials or steps that do not materially affect the basic and novel characteristics of the claim. In the present disclosure of various aspects, any of the terms “comprising”, “consisting essentially of” and “consisting of” used in the description of an aspect may be replaced with either of the other two terms.

All patents, patent applications (including provisional applications), and publications cited herein are incorporated by reference as if individually incorporated for all purposes. Unless otherwise indicated, all parts and percentages are by weight and all molecular weights are weight average molecular weights. The foregoing detailed description has been given for clarity of understanding only. No unnecessary limitations are to be understood therefrom. The invention is not limited to the exact details shown and described, for variations obvious to one skilled in the art will be included within the invention defined by the claims.

What is claimed is:

1. A process for preparing a Dried Functionalized Protein Product comprising:
comminuting meat to form a comminuted meat having particle size of less than 5 mm;
mixing the comminuted meat with water, a food grade alkaline composition, a food grade alkaline composition, and a food grade salt to form a Functionalized Protein Brine having a pH in the range of from about 4.0 to about 9.5, the mixing being carried out so that the meat is exposed to acid in a manner that would cause the pH of the meat to be less than about 5.3 at some time during the process to form the Functionalized Protein Brine; and
drying the Functionalized Protein Brine to form a Dried Functionalized Protein Product.

2. The process of claim 1, wherein the Dried Functionalized Protein Product when free of added starches and gums has an Emulsion Capacity of greater than 200 g oil/g protein.

3. The process of claim 1, wherein the Dried Functionalized Protein Product when free of added starches and gums does not exhibit K-Carrageenan Hydrocolloid Separation, or does not exhibit Iota-Carrageenan Hydrocolloid Separation, or does not exhibit Guar Gum Hydrocolloid Separation.

4. The process of claim 1, wherein the meat comprises poultry meat.

5. The process of claim 1, wherein the meat is selected from chicken and turkey.

6. The process of claim 4 or 5, wherein the Dried Functionalized Protein Product when free of added starches and gums has a Gel Hardness of greater than 90 g, or has a Gel Hardness of from about 90 g to about 300 g, or from about 90 g to about 200 g, or from about 90 g to about 150 g.

7. The process of claim 4 or 5, wherein the Dried Functionalized Protein Product when free of added starches and gums has a Foaming Capacity of greater than 60 ml foam/g protein.

8. The process of claim 4 or 5, wherein the Dried Functionalized Protein Product when free of added starches and gums has a Viscosity of greater than 3 Pa·s when measured at a shear rate of 0.1 l/s.

9. The process of claim 4 or 5, wherein the Dried Functionalized Protein Product when free of added starches and gums has a Viscosity of greater than 0.3 Pa·s when measured at a shear rate of 1.0 l/s.

10. The process of claim 1, wherein the meat is beef.

11. The process of claim 10, wherein the Dried Functionalized Protein Product when free of added starches and gums has a Viscosity of greater than 1 Pa·s when measured at a shear rate of 0.1 l/s.

12. The process of claim 10, wherein the Dried Functionalized Protein Product when free of added starches and gums has a Viscosity of greater than 0.2 Pa·s when measured at a shear rate of 1.0 l/s.

13. The process of claim 10, wherein the Dried Functionalized Protein Product when free of added starches and gums has a Gel Hardness of greater than 400 g, or has a Gel Hardness of from about 450 g to about 650 g, or from about 500 g to about 550 g.

14. A Dried Functionalized Protein Product made by the process of any one of claims 1, 4, 5 and 10.

15. The Dried Functionalized Protein Product of claim 14, wherein the Dried Functionalized Protein Product is free of added starches and gums.

16. A process for preparing a Reconstituted Functionalized Protein Formulation comprising:
reconstituting the Dried Functionalized Protein Product of claim 14 with sufficient water to form a Reconstituted Functionalized Protein Formulation having a meat content of from about 3 wt % to about 35 wt %.

17. A Reconstituted Functionalized Protein Formulation made by the process of claim 16.

18. A process of using the Reconstituted Functionalized Protein Formulation of claim 17, comprising incorporating said Reconstituted Functionalized Protein Formulation into a food system selected from the group consisting of a beverage and a sauce (such as a salad dressing).

19. A process of using the Reconstituted Functionalized Protein Formulation of claim 17, wherein the meat is poultry, comprising incorporating said Reconstituted Functionalized Protein Formulation into a food system selected from the group consisting of bread and a frozen foamed dessert (such as such as ice cream, frozen custard, frozen yogurt, sorbet, and gelato).

20. The process of claim 19, wherein the meat is selected from chicken and turkey.
